(19) United States
(12) Patent Application Publication
(10) Pub. No.: US 2019/0271299 A1
(43) Pub. Date: Sep. 5, 2019

(54) PLANETARY TRANSMISSION, WIND POWER PLANT WITH A PLANETARY MECHANISM, AND METHOD FOR OPERATING A PLANETARY TRANSMISSION

(71) Applicant: FLENDER GMBH, 46395 Bocholt (DE)

(72) Inventors: CHRISTIAN BIEDER, Hamminkeln (DE); RALF GETTLER, Borken (DE); KATHRIN BENOIT, Schermbeck (DE)

(73) Assignee: FLENDER GMBH, 46395 Bocholt (DE)

(21) Appl. No.: 16/345,525

(22) PCT Filed: Sep. 14, 2017
(86) PCT No.: PCT/EP2017/073080

§ 371 Date: Apr. 26, 2019

(30) Foreign Application Priority Data
Oct. 27, 2016 (EP) 16195980.4

(51) Int. Cl. F03D 80/70; F03D 15/00; F16H 1/28; F16H 57/04; F16H 57/08

(52) U.S. Cl. CPC F03D 80/70; F03D 15/00; F16H 1/28; F05B 2260/40311; F16H 57/0486; F16H 57/082; F05B 2260/98; F16H 57/043

(57) ABSTRACT

A planetary transmission includes a transmission part rotatable about an axis of rotation and having a discharging region. The transmission part has an end face formed with a recess for receiving lubricant from a receiving region and discharging received lubricant to the discharging region. A covering plate covers the recess in the transmission part and has an opening in communication with the recess so that the recess is open to the outside. The opening is positioned in peripheral direction of the transmission part centrally in the covering plate and in radial direction of the transmission part proximally with respect to the axis of rotation of the transmission part The opening has an area sized smaller than a base area of the recess. A duct extends from an interior of the recess to the discharging region at a minimal distance from the axis of rotation of the transmission part.

The invention relates to a planetary transmission, in particular a planetary transmission for a wind power plant. The invention is in principle also suitable for other transmission types and for applications beyond a use in a wind power plant.

With rotating systems, for instance a planetary transmission, there is in principle the problem that individual rotating parts of the rotating system are not lubricated or are not lubricated sufficiently in the event of failure of a pressurized oil supply.

On that basis an object of the present invention consists in specifying a solution which ensures such a lubrication.

This object is achieved according to the invention by means of a planetary transmission having the features of claim 1. Subsequently, with a planetary transmission with at least one rotatable part and means which are assigned to the rotatable part for receiving lubricant from a receiving region and for discharging the received lubricant in a discharging region, there is provision that the discharging region is located directly on the rotatable part, in other words for instance laterally on the rotatable part or inside the rotatable part, that a recess covered by means of a covering plate in the rotatable part acts as a means for receiving the lubricant, that the recess is open to the outside via an opening in the covering plate and that an area of the opening is smaller than a base area of the recess.

In its preamble, claim 1 is based on DE 10 2011 082 856 A1. A planetary carrier for a planetary, transmission of a wind power plant is known therefrom, which, in the installed state, rotates about an axis of rotation and has at least one conveyor, which is embodied such that it is able to convey lubricant from the receiving region to a discharging region when the planetary, carrier is rotating. In DE 10 2011 082 856 A1 the discharging region is a high speed shaft driven by means of the planetary transmission. The lubricant is firstly conveyed into a collecting vessel for its lubrication. A line is connected hereto, which leads to the high-speed shaft which is disposed lower than the collecting vessel. The discharging region is therefore disposed at a distance from the rotatable part, with which the lubricant is received.

The advantage of the solution proposed here consists in a lubrication of the respective rotatable/rotating part itself and/or a further rotatable/rotating part connected directly to the rotatable/rotating part being easily ensured. This renders known solutions unnecessary, such as, for instance a mechanical pump, an oil scraper, oil pans or oil pockets or oil chutes or oil blockage sheets.

The possibility of being able to is with a mechanical pump ensures the usability of the solution proposed here also for what is known as rolling operation of a wind power plant. During rolling operation of a wind power plant, an otherwise provided pressurized oil supply is then switched off, as is well-known on account of the then provided low rotational speeds of the rotor hub, and an oil sump of the planetary transmission of the wind power plant is flooded with a lubricant, in particular transmission oil. The respective rotatable part of the planetary transmission with the at least one recess formed therein receives a part of the lubricant from this oil sump (receiving region). The respective rotatable part acts with and for each further recess as a scoop (oil scoop). When the rotatable transmission part is rotated further, the covering plate above the recess and the positioning of the opening located therein ensure that at least one part of the lubricant received originally in the recess remains n the recess and with a continued further rotation under gravitational effect in the discharging region directly reaches the rotatable transmission part which acts as a scoop.

With a method for operating a planetary transmission of the type described here and below, the rotatable transmission part enters in a rotating fashion in sections into a lubricant reservoir in the receiving region, wherein upon entering the lubricant reservoir, lubricant enters the interior of the recess in the transmission part through the opening in the covering plate, wherein with the initial further rotation of the transmission part, at least one part of the lubricant entering the interior of the recess is held in the recess by means of the covering plate and wherein with a further rotation of the transmission part at least one part of the quantity of lubricant held in the recess enters a duct exiting the recess and continuing to the discharging region.

Advantageous embodiments of the invention form the subject matter of the subclaims. References used here indicate the further embodiment of the subject matter of the main claim by the features of the respective subclaim. They are not to be understood as dispensing with achieving an independent, objective protection for the feature combinations of the back-related subclaims. Furthermore, with respect to a design of the claims and the description with a closer specification of a feature in a subordinate claim, it is assumed that a restriction of this type is not present in the respective preceding claims and a more general embodiment of the objective planetary transmission. Each reference in the description to aspects of subordinate claims is accordingly also able to be read in detail as a description of optional features without specific reference.

In the peripheral direction of the rotatable part an opening positioned centrally in the covering plate with respect to the recess makes the receiving of lubricant by means of the recess independent of the respective direction of rotation of the transmission part.

A planetary transmission or a transmission of any type according to the approach proposed here is suitable for instance for use in a wind power plant. Accordingly, the invention is also a wind power plant with such a transmission, in particular a transmission of this type in the form of a planetary transmission.

Exemplary embodiments of the invention are explained in more detail below on the basis of the drawing. Objects or elements which correspond to one another are provided with the same reference characters in all the figures.

The or each exemplary embodiment is not understood to be a restriction of the invention. Instead, within the scope of the present disclosure, supplements and modifications are feasibly possible, particularly those which can be extracted for instance by combining or modifying individual features or method steps described in conjunction with the general or special description part and contained in the claims and/or the drawing for the person skilled in the art with respect to the solution of the object and due to combinable features lead to a new subject matter or new method steps or method step sequences.

The drawings show in:

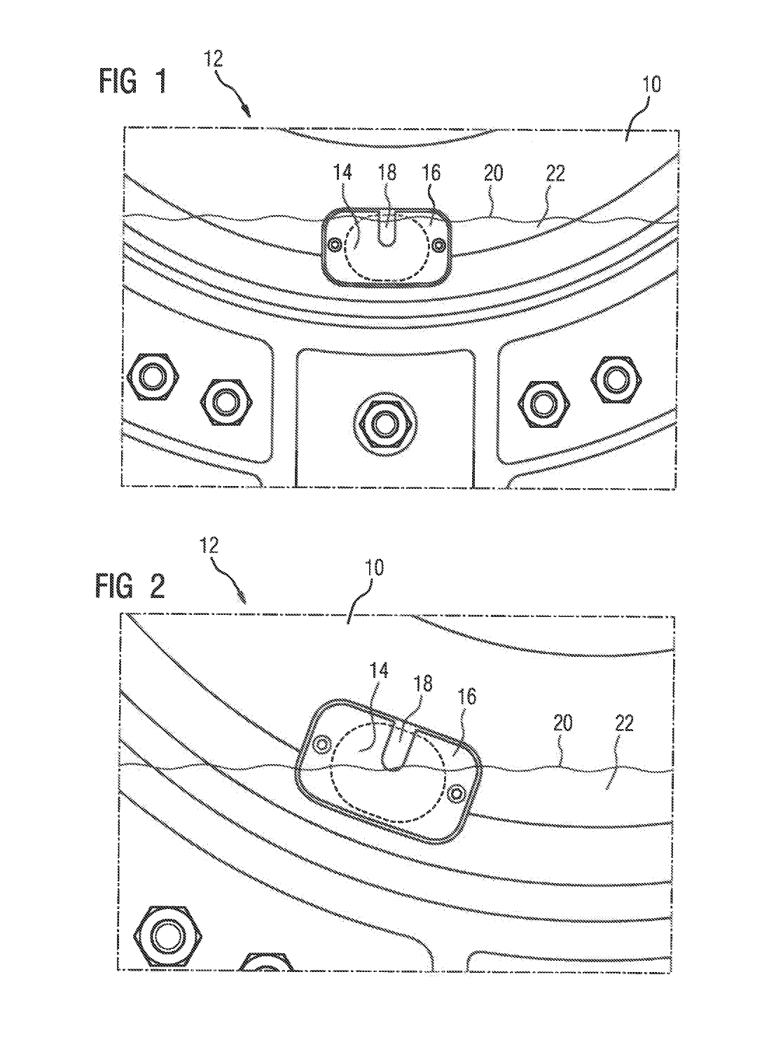

FIG. 1 a rotatable transmission part with a recess in an end face for receiving lubricant from a receiving region,

FIG. 2 and

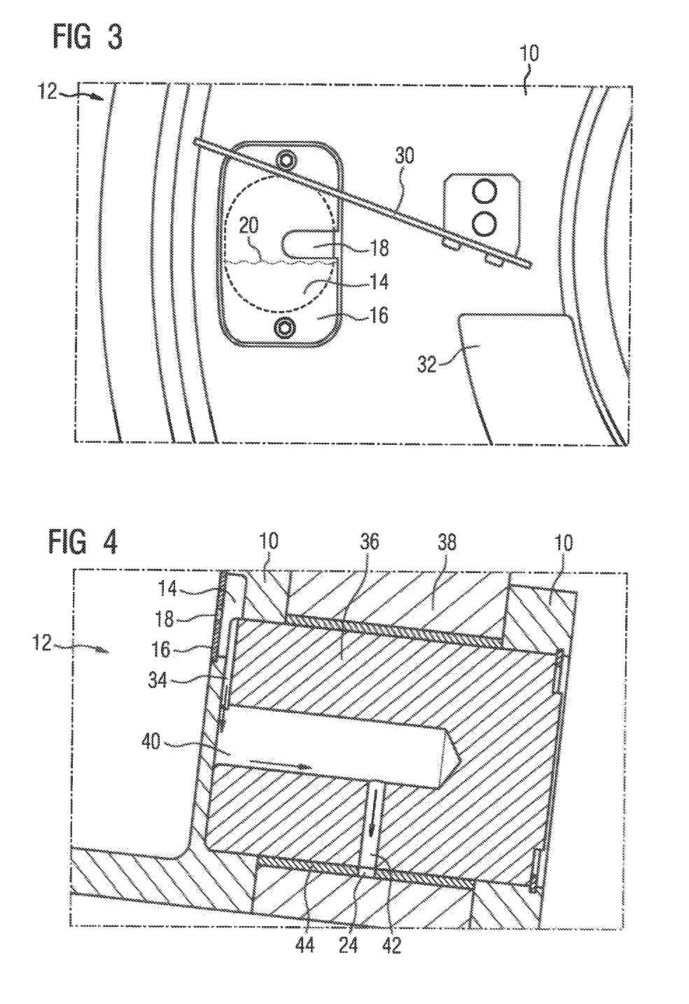

FIG. 3 different rotational positions of the transmission part according to FIG. 1,

FIG. 4 the transmission part according to FIG. 1 in a position for discharging the lubricant received by means of the recess in a discharging region directly on the rotating transmission part, namely inside the rotating transmission part,

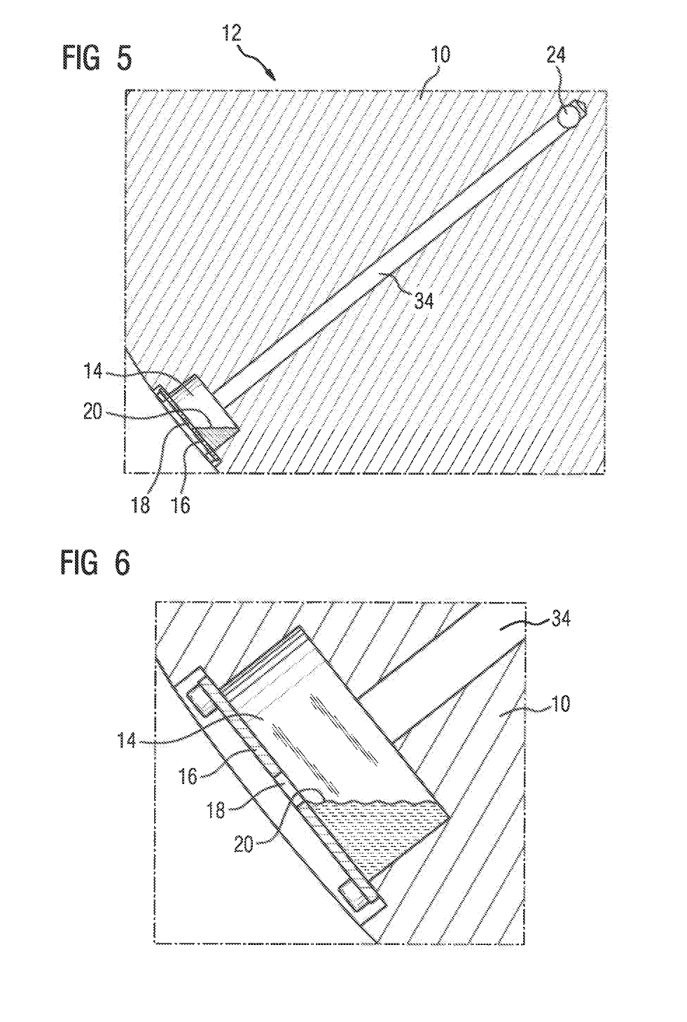

FIG. 5 a further embodiment of a rotatable transmission part with a recess for receiving lubricant from a receiving region, wherein the recess is formed in a lateral area of the transmission part,

FIG. 6 an enlarged cutaway view of the representation in FIG. 5,

FIG. 7 the transmission part according to FIG. 5 in a position for discharging the lubricant received by means of the recess and

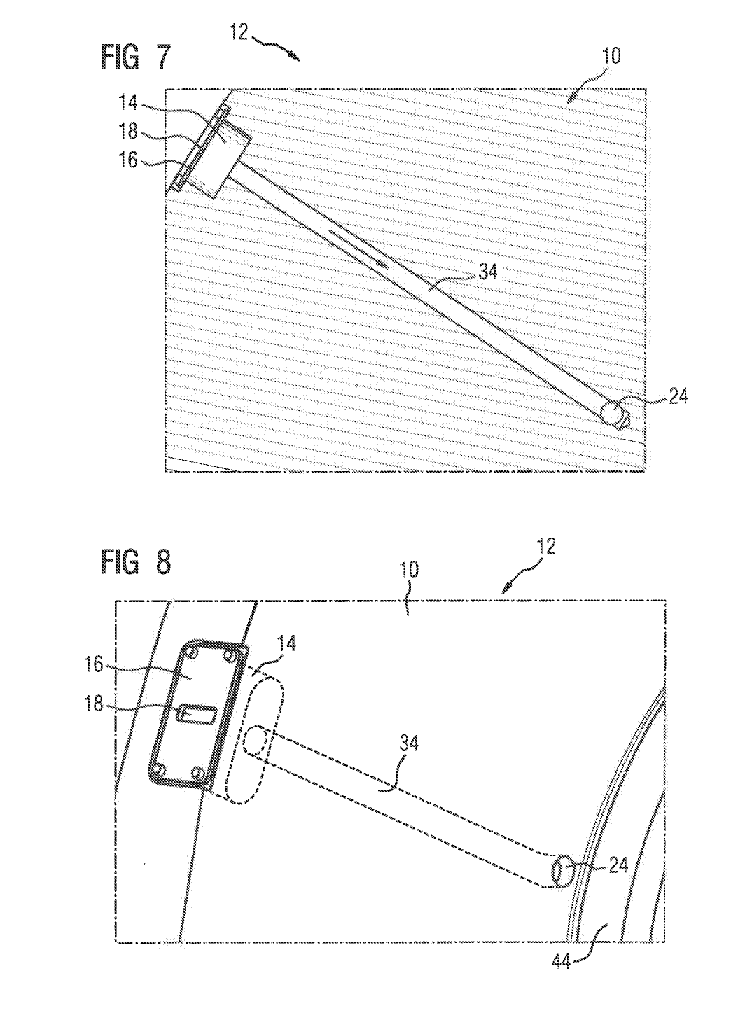

FIG. 8 the transmission part according to FIG. 5 with a discharging region directly on the rotating transmission part rendered accessible by means of a duct exiting from the recess, through which transmission part the lubricant leaves the recess under gravitational effect.

The representation in FIG. 1 shows, as an example of a rotatable part 10 of a transmission (transmission part) and without dispensing with a continuous generality, a section of a planetary carrier 10 of a planetary transmission 12 known per se but not itself shown further.

The planetary carrier 10 is shown in a top view on one of its end faces (one of the two typically parallel lateral end faces of the planetary carrier 10).

The planetary carrier 10 as a rotatable part of the planetary transmission 12 has, in the form of a recess 14 and a covering plate 16 covering the recess 14 with an opening 18 formed therein, means for receiving lubricant 20 from a receiving region 22 and for discharging the received lubricant 20 in a discharging region 24 (FIG. 4) into the interior of the rotatable planetary carrier 10, particularly for discharging to a planetary carrier 44.

In the representations in FIG. 1, FIG. 2 and FIG. 3, the recess 14 in the planetary carrier 10 is covered by the covering plate 16. The lubricant 20 is represented by a liquid mirror shown in the form of a horizontal line.

In the “6 o'clock position” of the planetary carrier 10 shown in FIG. 1, the recess 14 in the planetary carrier 10 is located at the lowest point and enters accordingly furthest into the lubricant 20 provided in a section of the transmission housing which acts as an oil sump for example. Lubricant 20 enters the recess 14 via the opening 18 and the recess 14 is therefore filled at least initially with lubricant 20.

In the representation in FIG. 2, a snapshot is shown while further rotating the planetary carrier 10 out of the “6 o'clock position” shown in FIG. 1. In doing this that position (rotational position of the planetary carrier 10) is selected, in which the opening 18 in the covering plate 16 projects precisely above the level of the lubricant 20. Lubricant 20 (FIG. 1) having entered the recess 14 previously here exits the recess 14 via the opening 18, wherein the covering plate 16 prevents a complete running out of the lubricant 20 from the recess 14, by the surface of the opening 18 being smaller than the base area of the recess 14.

In the representation in FIG. 3, a snapshot is shown when the planetary carrier 10 is rotated further. The planetary carrier 10 is now located in a “9 o'clock position” and the lubricant 20 retained in the recess 14 by means of the covering plate 16 is available there to just below the now horizontal opening 18. In any case, the covering plate 16 is still effective for retaining the lubricant 20 in the interior of the recess 14.

In the representation in FIG. 3, an oil scraper 30 is shown, which does not rotate with the planetary carrier 10 and is attached in a rotationally fixed manner to the transmission housing, for instance. The oil scraper 30 scrapes across a section of the end face of the planetary carrier 10 in a manner known per se and lubricant 20 received in the process runs along the oil scraper 30 in the direction of a receiving container 32. The representation of the oil scraper 30 should show that the recess 14 and its covering plate 16 does not prevent or rule out the use of such or similar means for receiving and relaying lubricant 20.

In the representation in FIG. 4, a section through the planetary carrier 10 according to FIG. 1 to FIG. 3 is shown along its axis of rotation. The axis of rotation of the planetary carrier 10 is inclined with respect to the horizontal. The recess 14 and its covering plate 16 are visible to the top left in the representation. A duct 34 connects the recess 14 in the interior of the planetary carrier 10, by way of which duct 34 the lubricant 20 received by means of the recess 14 in the interior of the planetary carrier 10 when the planetary carrier 10 is rotated can drain off in the direction of the discharging region 24. With the embodiment shown, the path of the lubricant 20 runs from the recess 14 up to the discharging region 24 via a first duct 34 in a limit range between the planetary carrier 10 and a planetary axis 36 mounted between the planetary carrier 10 and, then via an axial borehole 40 in the planetary axis 36 acting as a duct and from there to a continuing duct 42 in the direction of a bearing 44 and is effective there to lubricate the bearing of the planetary wheel 38. The resulting lubricant flow is illustrated in the representation in FIG. 4 by means of the arrows shown in the region of the ducts 34, 42 and the borehole 40.

In the embodiment shown, the recess 14 is milled or formed by another machining process, for instance in an end face of the rotatable transmission part 10, in one of the end faces of the planetary carrier 10.

The opening 18 is disposed in the peripheral direction of the rotatable transmission part 10, in the embodiment shown in the peripheral direction of the planetary carrier 10, centrally in the covering plate 16 and is aligned with its largest longitudinal axis in the direction of the axis of rotation (radial alignment). The opening 18 is disposed furthermore in the surface section of the covering plate 16 (proximal to the axis of rotation) facing the axis of rotation. The central positioning of the opening 18, together with the radial alignment, ensures a lubricant absorption by means of the recess 14 in a manner independent of the rotational direction. The positioning of the opening 18 in the covering plate 16 which is proximal to the axis of rotation ensures a further transportation of at least one part of the quantity of lubricant received by means of the recess 14 while the respective rotatable transmission part 10 rotates further.

The duct 34 inside the recess 14 connects to its base area. The base area of the recess 14 is the surface section of the recess 14 facing the covering plate 16. In general this can be worded such that the duct 34 exiting herefrom in the interior of the recess 14 and leading directly or indirectly to the discharging region 24 begins in a region of the recess 14 which faces the axis of rotation of the rotatable transmission part 10, in other words in a region of the recess 14 which is at a minimal distance from the axis of rotation.

The representations in FIG. 5, FIG. 6, FIG. 7 and FIG. 8 show an alternative embodiment of a planetary transmission 12 and a rotatable transmission part 10 included here in accordance with the approach proposed here. As an example of a rotatable transmission part 10, once again, clearly without dispensing with a continuous generality, a respective only partially shown planetary carrier 10 is selected.

With this embodiment, the recess 14 is located in a lateral area of the respective rotatable transmission part 10, in the situation shown in a lateral area of the planetary carrier 10. The function of the recess 14 also covered here by means of a covering plate 16 corresponds to the function already explained above. The covering plate 16 has an opening 18 positioned in particular in the peripheral direction of the planetary carrier 10 centrally in the covering plate 16, wherein an area of the opening 18 is smaller than the base area of the recess 14. With an opening 18 positioned centrally in the covering plate 16, the receiving of lubricant 20 by means of the recess 14 is independent of the respective direction of rotation of the planetary carrier 10.

In the position (rotational position) of the planetary carrier 10 shown in FIG. 5, which is shown in FIG. 5, FIG. 6 and FIG. 7 cut with a plane of intersection at right angles to the axis of rotation and through a side of the planetary carrier 10, a certain quantity of lubricant has already been received in a receiving region 22 by means of the recess 14, and lubricant 20 located in the recess 14 is retained by means of the covering plate 16. The lubricant 20 is present in the recess 14 just up to the lower edge of the opening 18 in the covering plate 16.

A “6 o'clock position” as in FIG. 1 is not shown for this embodiment. The receiving of the lubricant 20 by means of the recess 14 via the opening 18 in the covering plate 16 with a recess 14 entering the quantity of lubricant held there in the receiving region 22, corresponds however to the situation shown in FIG. 1, so that reference can be made hereto and to the associated description.

The representation in FIG. 6 shows an enlarged cutout from the representation in FIG. 5 with the recess 14 formed in the lateral area of the planetary carrier 10 for instance by means of milling or suchlike. There the retention of a certain quantity of lubricant in the recess 14 by means of the covering plate 16 and the mirror of the quantity of lubricant retained in the recess 14 which extends up to the lower edge of the opening 18 in the covering plate 16 can be better seen.

In the representation in FIG. 7, a position (rotational position) of the planetary carrier 10 is shown, in which lubricant 20 retained in the recess 14 by means of the covering plate 16 drains off via the duct 34 connecting to the recess 14 out of the recess 14 in the direction of a discharging region 24 (FIG. 8).

In FIG. 8 a section of the planetary carrier 10 according to FIG. 5 to FIG. 7 is shown in an isometric view and with partially visible contours in the interior of the planetary carrier 10. In this representation, the central positioning of the opening 18 in the covering plate 16 can be seen particularly well in the peripheral direction of the planetary carrier 10. Lubricant 20 which is forced through this opening 18 into the recess 14 with the rotation of the planetary carrier 10 by the receiving region 22, upon further rotation of the planetary carrier 10, in other words approximately in the position of the planetary carrier 10 shown in FIG. 8, drains out of the recess 14 via the duct 34 connecting to the recess 14 and reaches a discharging region 24 laterally on the planetary carrier 10, for instance a bearing 44 of the planetary carrier 10. The lubricant 20 acts there to lubricate the bearing.

Although the invention has been illustrated and described in more detail by the exemplary embodiment, the invention is not restricted by the example or examples disclosed and other variations can be derived herefrom by the person skilled in the art without departing from the scope of protection of the invention.

Individual aspects to the fore of the description filed here can be summarized briefly as follows: Specified are a planetary transmission 12 with at least one rotatable part 10 and means 14, 16, 18 which are assigned to the rotatable part 10 for receiving lubricant 20 from a receiving region 22 and for discharging the received lubricant 20 in a discharging region 24 directly on the respective rotatable part 10, wherein a recess 14 which is covered by means of a covering plate 16, in the rotatable part 10 acts as means 14, 16, 18 for receiving the lubricant 20, wherein the recess 14 is open to the outside via an opening 18 in the covering plate 16 and wherein an area of the opening 18 is smaller than a base area of the recess 14, and a wind power plant with one such planetary transmission 12 and a method for operating one such planetary transmission 12. The discharging region 24 is therefore located according to the innovation presented here directly on the rotating system, in other word on the rotating part 10 which also acts to convey the lubricant 20. The invention is in principle also suitable for other transmission types and for applications beyond a use in a wind power plant.

What is claimed is:

1.-5. (canceled)

6. A planetary transmission, comprising:
a transmission part rotatable about an axis of rotation and having a discharging region, said transmission part having an end face formed with a recess for receiving lubricant from a receiving region and discharging received lubricant to the discharging region;
a covering plate covering the recess in the transmission part and having an opening in communication with the recess so that the recess is open to the outside, said opening positioned in peripheral direction of the transmission part centrally in the covering plate and in radial direction of the transmission part proximally with respect to the axis of rotation of the transmission part, said opening having an area sized smaller than a base area of the recess; and
a duct extending from an interior of the recess to the discharging region in close proximity to the axis of rotation of the transmission part.

7. The planetary transmission of claim 6, wherein the recess is formed in a lateral area of the transmission part.

8. A wind power plant, comprising a planetary transmission, said planetary transmission comprising a transmission part rotatable about an axis of rotation and having a discharging region, said transmission part having an end face formed with a recess for receiving lubricant from a receiving region and discharging received lubricant to the discharging region, a covering plate covering the recess in the transmission part and having an opening in communication with the recess so that the recess is open to the outside, said opening positioned in peripheral direction of the transmission part centrally in the covering plate and in radial direction of the transmission part proximally with respect to the axis of rotation of the transmission part, said opening having an area sized smaller than a base area of the recess, and a duct extending from an interior of the recess to the discharging region in close proximity to the axis of rotation of the transmission part.

9. The wind power plant of claim 8, wherein the recess is formed in a lateral area of the transmission part.

10. A method for operating a planetary transmission, said method comprising:
allowing a rotatable transmission part of the planetary transmission upon rotation to enter with at least one portion into a lubricant reservoir in a receiving region;
causing lubricant in the lubricant reservoir to flow to an interior of a recess of the transmission part via an opening in a covering plate that covers the recess, when the lubricant enters the lubricant reservoir;
retaining at least part of the lubricant entering the interior of the recess by the covering plate, as the transmission part continues to rotate; and
transferring at least part of the lubricant retained in the recess via a duct to a discharging region of the transmission part upon further rotation of the transmission part.
